(19) United States
(12) Patent Application Publication
(10) Pub. No.: US 2014/0175966 A1
(43) Pub. Date: Jun. 26, 2014

(54) LED LAMP

(71) Applicant: CREE, INC., Durham, NC (US)

(72) Inventor: Tien Wei Tan, Penang (MY)

(73) Assignee: CREE, INC., Durham, NC (US)

(21) Appl. No.: 13/783,700

(22) Filed: Mar. 4, 2013

(30) Foreign Application Priority Data
Dec. 21, 2012 (MY) PI 2012005545

(51) Int. Cl. F21V 7/20

(52) U.S. Cl. CPC F21V 7/20
USPC 313/46

(57) ABSTRACT

A lamp comprises an LED light source for emitting light. A combined heat sink and reflector is thermally coupled to the LED light source. The heat sink and reflector comprise an internal surface for reflecting the light and an exterior surface. The internal surface and the external surface are uncovered such that heat is dissipated from the interior surface and the exterior surface.

### BACKGROUND

Light emitting diode (LED) lighting systems are becoming more prevalent as replacements for older lighting systems. LED systems are an example of solid state lighting (SSL) and have advantages over traditional lighting solutions such as incandescent and fluorescent lighting because they use less energy, are more durable, operate longer, can be combined in multi-color arrays that can be controlled to deliver virtually any color light, and generally contain no lead or mercury. A solid-state lighting system may take the form of a lighting unit, light fixture, light bulb, or a “lamp.”

An LED lighting system may include, for example, a packaged light emitting device including one or more light emitting diodes (LEDs), which may include inorganic LEDs, which may include semiconductor layers forming p-n junctions and/or organic LEDs (OLEDs), which may include organic light emission layers. Light perceived as white or near-white may be generated by a combination of red, green, and blue (“RGB”) LEDs. Output color of such a device may be altered by separately adjusting supply of current to the red, green, and blue LEDs. Another method for generating white or near-white light is by using a lumiphor such as a phosphor. Still another approach for producing white light is to stimulate phosphors or dyes of multiple colors with an LED source. Many other approaches can be taken.

An LED lamp may be made with a form factor that allows it to replace a standard incandescent bulb, or any of various types of fluorescent lamps. LED lamps often include some type of optical element or elements to allow for localized mixing of colors, collimate light, or provide a particular light pattern. Sometimes the optical element also serves as an envelope or enclosure for the electronics and or the LEDs in the lamp.

Since, ideally, an LED lamp designed as a replacement for a traditional incandescent or fluorescent light source needs to be self-contained; a power supply is included in the lamp structure along with the LEDs and the optical components. A heatsink is also often needed to cool the LEDs and/or power supply in order to maintain appropriate operating temperature.

### SUMMARY OF THE INVENTION

In some embodiments, a lamp comprises an LED light source for emitting light. A combined heat sink and reflector surround the LED light source. The heat sink and reflector comprises an internal surface for reflecting the light and an exterior surface. The internal surface and the external surface are uncovered such that heat is dissipated from the interior surface and the exterior surface.

An optical element may receive the light and may be located in the heat sink and reflector. The interior surface may be a parabolic reflector. The interior surface may be a multifaceted reflector. The outer surface may comprise a heat sink structure. The heat sink structure may comprise fins. The LED light source may emit white light. The LED light source may comprise at least one LED mounted on a substrate. The substrate may comprise a printed circuit board. The substrate may be thermally coupled to the heat sink and reflector. The interior surface may be open to the ambient environment. An electrical conductor may be provided for connecting the lamp to a power source. The electrical connector may be an Edison screw or pins. The heat sink and reflector may be made of a thermally conductive material. The thermally conductive material may comprise aluminum.

In some embodiments, a lamp comprises an LED light source for emitting light. A combined heat sink and reflector is thermally coupled to the LED light source. The heat sink and reflector comprises an internal surface for reflecting the light and an exterior surface. The internal surface and the external surface are uncovered such that heat is dissipated from the interior surface and the exterior surface.

### BRIEF DESCRIPTION OF THE DRAWINGS

FIG. 1 is a section view of a prior art lamp.

FIG. 2 is a section view of another prior art lamp.

FIG. 3 is a perspective view of an embodiment of the lamp of the invention.

FIG. 4 is a section view of the lamp of FIG. 3.

FIG. 5 is a section view of another embodiment the lamp of the invention.

### DETAILED DESCRIPTION

Embodiments of the present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element such as a layer, region or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” or “top” or “bottom” may be used herein to describe a relationship of one element, layer or region to another element, layer or region as illustrated in the figures. It will be understood that these terms are intended to encompass different orientations of the device in addition to the orientation depicted in the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof. Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

Unless otherwise expressly stated, comparative, quantitative terms such as “less” and “greater”, are intended to encompass the concept of equality. As an example, “less” can mean not only “less” in the strictest mathematical sense, but also, “less than or equal to.”

It should be noted that the term “lamp” is meant to encompass not only a solid-state replacement for a traditional incandescent bulb as illustrated herein, but also replacements for fluorescent bulbs, replacements for complete fixtures, and any type of light fixture that may be designed as a solid state fixture.

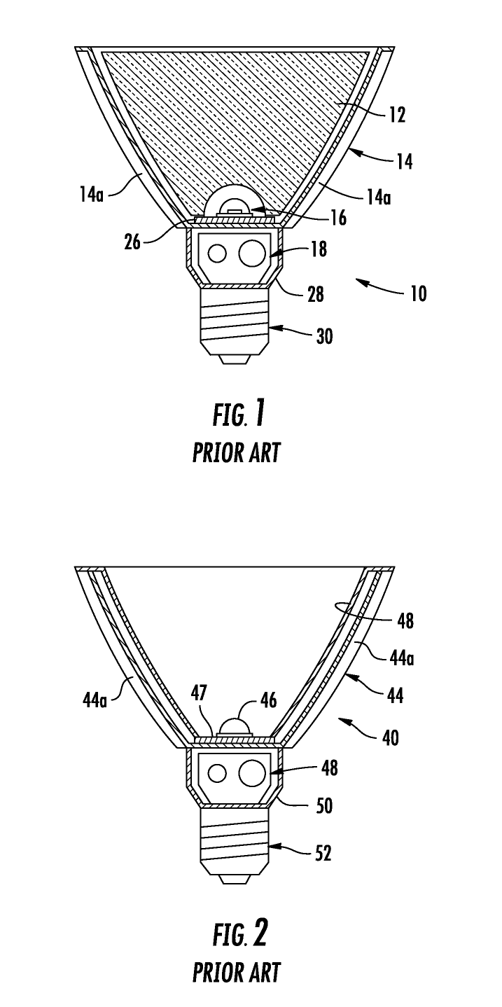

Referring to FIG. 1 an embodiment of a prior art LED-based, solid-state lamp 10 is shown. Lamp 10 may include an LED light source 16 that may comprise one or more LEDs or LED packages. The LED light source 16 is mounted on a substrate 26 such as a printed circuit board (PCB). A power supply 18 is provided that includes electrical components to provide the proper voltage and current to the LED light source 16 within lamp 10. The power supply 18 may be contained in a housing 28 that is connected to the heat sink 14. An electrical connector 30 is provided to connect the lamp to a source of power. In some embodiments connection pins may be used to provide a standard connection to power rails, which may be AC or DC supply rails. The connector 30 may also comprise an Edison screw as shown for connecting the lamp to an Edison socket.

Lamp 10 may include a TIR optical element 12. While a TIR optical element is shown a variety of optical elements may be used for receiving the light from the LED light source 16 and emitting the light in a desired light pattern. Lamp 10 also includes a heat sink 14 that may be made of aluminum or other thermally conductive material and may comprise a plurality of fins 14a for dissipating heat to the ambient environment. The heat sink 14 is thermally coupled to the substrate 26 for conducting heat from the substrate to the ambient environment. The optical element is disposed closely adjacent to the heat sink 14 and covers substantially the entire interior surface of the heat sink such that heat is dissipated primarily to the exterior of the lamp.

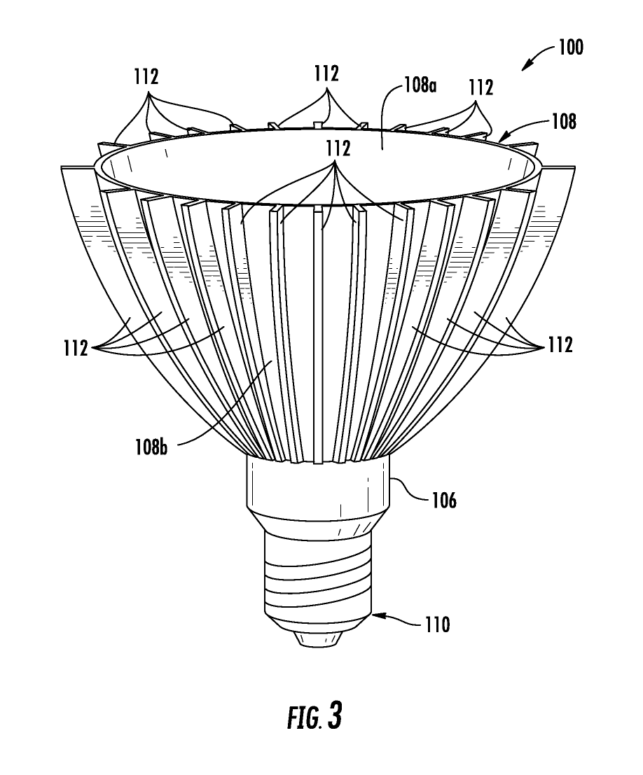

Referring to FIG. 2 an embodiment of a prior art LED based solid state replacement for a PAR lamp is shown. Lamp 40 comprises an LED light source 46 that may comprise one or more LEDs or LED packages. The LED source is mounted on a substrate 47 such as a printed circuit board (PCB). Lamp 40 also includes a heat sink 44 that may be made of aluminum or other thermally conductive material and may comprise a plurality of fins 44a for dissipating heat to the ambient environment. The heat sink 44 is thermally coupled to the substrate 46 for conducting heat from the substrate 47 to the ambient environment. A power supply 48 is provided that includes electrical components to provide the proper voltage and current to the LED light source 46 within lamp 40. The power supply 48 may be contained in a housing 50 that is connected to the heat sink 44. In some embodiments connection pins may be used to provide a standard connection to power rails, which may be AC or DC supply rails. The connector 52 may also comprise an Edison screw as shown for connecting the lamp to an Edison socket.

A diffuse, white, highly reflective reflector 48 may be provided within the heat sink structure 44 of lamp 10, so that the reflector is dispposed substantially adjacent to the heat sink structure 44. Reflector 48 is molded or thermoformed into the desired shape to fit together within the heat sink portion of the lamp. The reflector 48 can be made of many different materials, including materials that are made reflective by application of a coating, reflective paint, or the like. The reflector 48 may surround the LED light source 46 to reflect the light in a desired pattern. The reflector 48 may comprise a parabolic reflective surface. The reflector 48 is disposed closely adjacent to the heat sink 14 and covers substantially the entire interior surface of the heat sink such that heat is dissipated primarily from the exterior of the lamp.

A reflector, similar to that shown and described with respect to FIG. 2, may also be located between the optical element 12 and heat sink 14 in the embodiment of FIG. 1 to reflect light that escapes from the optical element 12 back into the optical element 12 for another opportunity to eventually be transmitted or reflected from the exit surface of the optical element. The reflector typically extends over the entire area of the optical element 12 and the heat sink structure. The reflector 48 extends over the entire interior surface of the heat sink 44 such that heat is dissipated primarily from the exterior of the lamp.

In the prior art device described with respect to FIG. 1 the optical element 12 acts as a thermal insulator such that heat that is transferred to the heat sink 14 from the LED light source 16 is dissipated substantially from the exterior surface of the heat sink 14 to the exterior of the lamp. Likewise, in the prior art device described with respect to FIG. 2 the reflector 48 acts as a thermal insulator such that heat that is transferred to the heat sink from the LED light source 46 is dissipated substantially from the exterior surface of the heat sink 44 to the exterior of the lamp. In both prior art devices, very little heat is dissipated from the interior surface of heat sink because the optical element and/or the reflector cover substantially the entire interior surface of the heat sink. The thermal insulating properties of the heat optical element 12 and the reflector 48 prevent a significant amount of heat to be dissipated from the interior surface of the heat sink.

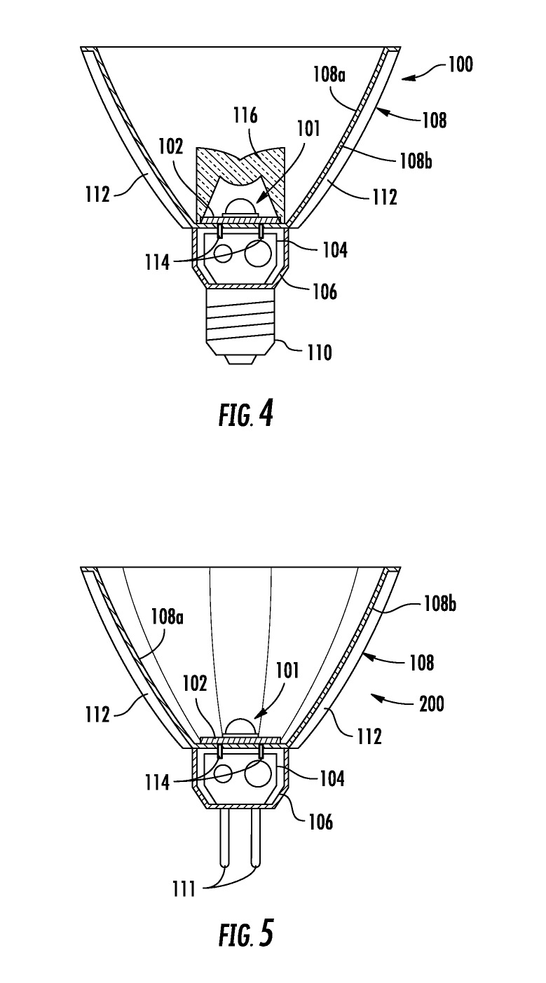

An embodiment of the lamp 100 of the invention is shown in FIGS. 3 and 4 and comprises an LED light source 101 that may comprise one or more LEDs or LED packages . The LED light source 101 is mounted on a substrate 102 such as a printed circuit board (PCB). A power supply 104 is provided that includes electrical components to provide the proper voltage and current to the LED light source 101 within lamp 100. The power supply 104 may be contained in a housing 106 that is connected to the combined heat sink and reflector 108. In some embodiments connection pins (see FIG. 5) may be used to provide a standard connection to power rails, which may be AC or DC supply rails. The connector 52 may also comprise an Edison screw 110 as shown in FIGS. 3 and 4 for connecting the lamp to an Edison socket. Other connectors may be used to provide power to the lamp in other applications. Such a lamp may be used as a solid-state replacement for a standard, MR 16 or PAR type bulb.

The terms “LED” and “LED device” and “LED package” as used herein may refer to any solid-state light emitter. The terms “solid state light emitter” or “solid state emitter” may include a light emitting diode, laser diode, organic light emitting diode, and/or other semiconductor device which includes one or more semiconductor layers, which may include silicon, silicon carbide, gallium nitride and/or other semiconductor materials, a substrate which may include sapphire, silicon, silicon carbide and/or other microelectronic substrates, and one or more contact layers which may include metal and/or other conductive materials. A solid-state lighting device produces light (ultraviolet, visible, or infrared) by exciting electrons across the band gap between a conduction band and a valence band of a semiconductor active (light-emitting) layer, with the electron transition generating light at a wavelength that depends on the band gap. Thus, the color (wavelength) of the light emitted by a solid-state emitter depends on the materials of the active layers thereof. In various embodiments, solid-state light emitters may have peak wavelengths in the visible range and/or be used in combination with lumiphoric materials having peak wavelengths in the visible range. Multiple solid state light emitters and/or multiple lumiphoric materials (i.e., in combination with at least one solid state light emitter) may be used in a single device, such as to produce light perceived as white or near white in character. In certain embodiments, the aggregated output of multiple solid-state light emitters and/or lumiphoric materials may generate warm white light output having a color temperature range of from about 2200K to about 6000K.

Solid state light emitters may be used individually or in combination with one or more lumiphoric materials (e.g., phosphors, scintillators, lumiphoric inks) and/or optical elements to generate light at a peak wavelength, or of at least one desired perceived color (including combinations of colors that may be perceived as white). Inclusion of lumiphoric (also called ‘luminescent’) materials in lighting devices as described herein may be accomplished by direct coating on solid state light emitter, adding such materials to encapsulants, adding such materials to lenses, by embedding or dispersing such materials within lumiphor support elements, and/or coating such materials on lumiphor support elements. Other materials, such as light scattering elements (e.g., particles) and/or index matching materials, may be associated with a lumiphor, a lumiphor binding medium, or a lumiphor support element that may be spatially segregated from a solid state emitter.

The LEDs in the LED light source 101 may comprise a LED die disposed in an encapsulant such as silicone. The LEDs may be encapsulated with a phosphor to provide local wavelength conversion, as will be described later when various options for creating white light are discussed. Electrical conductors 114 run between the substrate 102 and the lamp base 106 to carry both sides of the supply to provide critical current to the LEDs. Circuitry 104 may include a power supply or driver and form all or a portion of the electrical path between the mains and the LEDs. The base may also include only part of the power supply circuitry while some components may reside external to the lamp or on the substrate. With the embodiments of FIGS. 3-5, as with many other embodiments of the invention, the term “electrical path” can be used to refer to the entire electrical path to the LED light source, including an intervening power supply disposed between the electrical connection that would otherwise provide power directly to the LEDs in the LED light source, or it may be used to refer to the connection between the mains and all the electronics in the lamp, including the power supply. The term may also be used to refer to the connection between the power supply and the LED light source.

LEDs and/or LED packages used with embodiments of the invention can include light emitting diode chips that emit hues of light that, when mixed, are perceived in combination as white light. Phosphors can be used as described to add yet other colors of light by wavelength conversion. For example, blue or violet LEDs can be used in the LED light source of the lamp and the appropriate phosphor can be in any of the ways mentioned above. LED devices can be used with phosphorized coatings packaged locally with the LEDs or with a phosphor coating the LED die as previously described. For example, blue-shifted yellow (BSY) LED devices, which typically include a local phosphor, can be used with a red phosphor on or in the optically transmissive enclosure or inner envelope to create substantially white light, or combined with red emitting LED devices in the array to create substantially white light. Such embodiments can produce light with a CRI of at least 70, at least 80, at least 90, or at least 95. By use of the term substantially white light, one could be referring to a chromacity diagram including a blackbody locus of points, where the point for the source falls within four, six or ten MacAdam ellipses of any point in the blackbody locus of points.

A lighting system using the combination of BSY and red LED devices referred to above to make substantially white light can be referred to as a BSY plus red or “BSY+R” system. In such a system, the LED devices used include LEDs operable to emit light of two different colors. In one example embodiment, the LED devices include a group of LEDs, wherein each LED, if and when illuminated, emits light having dominant wavelength from 440 to 480 nm. The LED devices include another group of LEDs, wherein each LED, if and when illuminated, emits light having a dominant wavelength from 605 to 630 nm. A phosphor can be used that, when excited, emits light having a dominant wavelength from 560 to 580 nm, so as to form a blue-shifted-yellow light with light from the former LED devices. In another example embodiment, one group of LEDs emits light having a dominant wavelength of from 435 to 490 nm and the other group emits light having a dominant wavelength of from 600 to 640 nm. The phosphor, when excited, emits light having a dominant wavelength of from 540 to 585 nm. A further detailed example of using groups of LEDs emitting light of different wavelengths to produce substantially while light can be found in issued U.S. Pat. No. 7,213,940, which is incorporated herein by reference.

Lamp 100 comprises a combined heat sink and reflector 108 that may be made of aluminum or other thermally conductive material for dissipating heat to the ambient environment. The heat sink and reflector are integrally formed in a single component and in some embodiments the heat sink and reflector 108 may be made of one-piece. In other embodiments the heat sink and reflector may be made of multiple elements secured to one another to create an integral heat sink and reflector 108 provided the heat sink and reflector may reflect light in a desired pattern and dissipate heat from both the interior surface and the exterior surface. The heat sink and reflector 108 is thermally coupled to the substrate 102 for conducting heat from the substrate 102 to the ambient environment. For example, the substrate 102 may be mounted on the heat sink and reflector 108 or the heat sink and reflector 108 may be thermally coupled to the substrate 102 by intervening thermally conductive elements. An optical element 116, such as a lens, is provided in the interior of the heat sink and reflector 108 to shape and color mix the light emitted by the LED light source 101. The optical element 116 may be made of acrylic or other suitable material. The optical element is arranged to receive light from the LED light source 101 and to project light in a desired pattern. In some embodiments the optical element 116 may project some or all of the emitted light onto the interior surface 108a of the reflector 108.

As shown, the optical element 116 is arranged such that the optical element 116 is spaced from and does not cover the interior surface 108a of the heat sink and reflector 108. The LED light source 101 and the optical element 116 are mounted in the heat sink and reflector 108 such that the inner surface 108a of the heat sink and reflector 108 is not covered by the optical element 116. As is shown in the figures, the outer surface 108b and the inner surface 108a of the heat sink and reflector 108 are uncovered and are exposed to the ambient environment such that heat may be dissipated from both sides of the heat sink and reflector 108. The exterior surface 108b of the heat sink and reflector 108 may be provided with fins 112 or other heat dissipating structure such that the heat transfer to the ambient environment is increased. The interior surface 108a of the heat sink and reflector 108 is provided with a suitable shape and size such that the interior surface 108a reflects the light from the LED light source 101 in a desired pattern. In some embodiments, the interior surface 108a is formed as a parabolic reflector suitable for use as a replacement for a PAR style lamp (FIG. 4). In other embodiments the interior surface 108a may be formed as a multi-faceted reflector suitable for use as a replacement for a MR style lamp (FIG. 5). Other configurations of the interior surface 108a may also be used. The interior surface 108a may be provided by any suitable reflective material provided the reflective material is capable of thermally dissipating heat from the LED light source 101 and substrate 102. Heat dissipation occurs by convection and radiation from both interior surface 108a and the exterior surface 108b of the heat sink and reflector 108.

Another embodiment of a lamp 200 according to the invention is shown in FIG. 5. In the embodiment of FIG. 5 like reference numerals are used to identify like components previously described with reference to FIGS. 3 and 4. In the embodiment of FIG. 5 the optical element 116 of FIG. 4 is eliminated such that the shaping of the light emitted from the lamp is accomplished using the interior surface 108a of the heat sink and reflector 108. The embodiment of FIG. 5 also shows pins 111 as the electrical connector, such are used in a MR style lamp, rather than the Edison screw of the embodiment of FIG. 4.

In the embodiments of FIGS. 4 and 5 the interior surface 108a of the combined heat sink and reflector 108 is uncovered by other lamp components such that heat may be dissipated from the lamp from the interior surface 108a. Comparing the lamps of FIGS. 4 and 5 to the lamps of FIGS. 1 and 2, the interior surfaces 108a of the heat sink and reflectors 108 are uncovered and are exposed to the ambient environment without being covered by device that functions to thermally insulate the heat sink. As a result heat may be dissipated from the heat sink and reflector 108 from both sides of the heat sink structure to increase the dissipation of heat from the LED light source 101. As used herein the terms “uncovered” and “exposed to” means that the interior surface 108a of the heat sink and reflector 108 is in sufficient contact with the ambient environment that heat may be transferred to the air surrounding the lamp to effect cooling of the LED light source. In some embodiments the entire interior surface 108a is uncovered while in other embodiments a small area of the interior surface 108a may be covered but the major portion of the interior surface is uncovered.

Although specific embodiments have been illustrated and described herein, those of ordinary skill in the art appreciate that any arrangement, which is calculated to achieve the same purpose, may be substituted for the specific embodiments shown and that the invention has other applications in other environments. This application is intended to cover any adaptations or variations of the present invention. The following claims are in no way intended to limit the scope of the invention to the specific embodiments described herein.

1. A lamp comprising:
an LED light source for emitting light;
a heat sink and reflector surrounding the LED light source, the heat sink and reflector comprising an interior surface for reflecting the light and an exterior surface, an optical element disposed in the heat sink and reflector that receives all of the light emitted from the LED light source for shaping and mixing the light emitted from the LED light source, the optical element being positioned such that the interior surface and the exterior surface of the heat sink and reflector are uncovered such that heat is dissipated from the interior surface and the exterior surface.

2. (canceled)

3. The lamp of claim 1 wherein the interior surface is a parabolic reflector.

4. The lamp of claim 1 wherein the interior surface is a multifaceted reflector.

5. The lamp of claim 1 wherein the exterior surface comprises a heat sink structure.

6. The lamp of claim 1 wherein the heat sink structure comprises fins.

7. The lamp of claim 1 wherein the LED light source emits white light.

8. The lamp of claim 1 wherein the LED light source comprises at least one LED mounted on a substrate.

9. The lamp of claim 8 wherein the substrate comprises a printed circuit board.

10. The lamp of claim 8 wherein the substrate is thermally coupled to the heat sink and reflector.

11. The lamp of claim 1 wherein the interior surface is exposed to the ambient environment.

12. The lamp of claim 1 further comprising an electrical connector for connecting the lamp to a power source.

13. The lamp of claim 12 wherein the electrical connector is an Edison screw.

14. The lamp of claim 12 wherein the electrical connector comprises pins.

15. The lamp of claim 1 wherein the heat sink and reflector is made of a thermally conducive material.

16. The lamp of claim 15 wherein the thermally conductive material comprises aluminum.

17. A lamp comprising:
an LED light source for emitting light;
a heat sink and reflector thermally coupled to the LED light source, the heat sink and reflector comprising an interior surface for reflecting the light and an exterior surface, an optical element disposed in the heat sink and reflector that receives all of the light emitted from the LED light source for shaping and mixing the light emitted from the LED light source, the optical element being positioned such that the interior surface and the exterior surface of the heat sink and reflector are uncovered such that heat is dissipated from the interior surface and the exterior surface.

18. The lamp of claim 17 wherein the exterior surface comprises a heat sink structure.

19. The lamp of claim 18 wherein the heat sink structure comprises fins.

20. The lamp of claim 17 wherein the LED light source comprises at least one LED mounted on a substrate where the substrate is thermally coupled to the heat sink and reflector.

21. The lamp of claim 17 wherein the interior surface is exposed to the ambient environment.
